(19) United States
(12) Patent Application Publication
(10) Pub. No.: US 2024/0199959 A1
(43) Pub. Date: Jun. 20, 2024

(54) PYROLYSIS OF BIOMASS

(71) Applicant: Rijksuniversiteit Groningen, Groningen (NL)

(72) Inventors: Hero Jan HEERES, Groningen (NL); Jozef Gerhardus Maria WINKELMAN, Groningen (NL); Erwin WILBERS, Groningen (NL); Balaji SRIDHARAN, Groningen (NL)

(21) Appl. No.: 18/286,787

(22) PCT Filed: Apr. 13, 2022
(86) PCT No.: PCT/EP2022/059898

§ 371 Date: Oct. 13, 2023

(30) Foreign Application Priority Data
Apr. 14, 2021 (NL) 2027965

(51) Int. Cl. C10B 53/02

(52) U.S. Cl. CPC C10B 53/02

(57) ABSTRACT

The invention relates to a process for the pyrolysis of biomass, the process comprising the steps of a) providing the biomass, b) providing a salt, c) combining the biomass and the salt, d) feeding the combined biomass and salt to an extruder, e) heating the combined biomass and salt in the extruder, thereby melting the salt if solid, and dissolving and/or dispersing the biomass in the molten salt, f) transporting the mixture through the extruder at pyrolysis conditions, thereby creating liquid pyrolysis products, gases, and char, g) removing the liquid pyrolysis products, gases, char and salt from the extruder, and h) separating the liquid pyrolysis products from the salt, the gases and the char.

The invention relates to a process for the pyrolysis of biomass.

### BACKGROUND ART

Pyrolysis, i.e. thermal decomposition in the absence of oxygen, is an environmentally attractive thermochemical process for conversion of biomass to energy products intended to replace fossil fuel derived energy products. The products of biomass pyrolysis include bio-char, bio-oil, and gases including methane, hydrogen, carbon monoxide, and carbon dioxide. Several types of feedstock can be used, from energy crops to agricultural or forestry residues and biogenic waste. A large part of the feedstock is comprised of lignocellulosic biomass. Lignocellulosic biomass refers to plant dry matter, and is mainly composed of cellulose, hemicellulose and lignin. Lignin is the second most abundant natural polymer, representing 30% of the weight and 40% of the energy content of lignocellulosic biomass. Lignin is however notorious for its difficult handling in pyrolysis processes. The consistency of the solids makes dosing of the material into the high-temperature (and in some cases: high pressure) equipment needed for pyrolysis cumbersome. At higher temperatures, lignin turns into a paste, similar to putty, and becomes even more difficult to dose or handle.

With respect to processing, pyrolysis processes can be categorized as slow or fast. Slow pyrolysis takes several hours to complete and results in biochar as the main product. This process has been used for many years to produce charcoal. On the other hand, fast pyrolysis typically takes less than an hour, and may in some cases take only minutes to seconds to complete. Fast pyrolysis yields a significant amount of bio-oil, e.g. over 50 wt % with respect to the weight of the biomass. Bio-oil is a preferred product as it may be upgraded to render it suitable as a refinery feedstock to replace crude oil derived from petroleum. This invention relates to fast pyrolysis of biomass.

Several kinds of reactors can be used for pyrolysis including those involving high heat and mass transfer rates such as spouted, and fluidized beds. Other reactors comprise autoclaves, melting vessels, plasma reactors and particular arrangements to enable vacuum pyrolysis. Similarly, it is also possible to find rotary kilns, rotating cones, cyclonic reactors, and the ablative process, among others.

Extruders are gaining attention as pyrolysis reactors. They are of relatively simple design and overcome some of the problems of conveying heat for pyrolyzing biomass. Moreover, extrusion is a continuous process. Continuous processes are highly preferred in terms of equipment costs and production rates.

Especially preferred extruders are auger reactors, which use one or more screws to convey a single feedstock or a blend with solid heat carriers down the length of a tube. The typical auger conveyor consists of a helical screw rotating in an enclosed shell.

Performing pyrolysis in an extruder, such as an auger reactor further has the advantage that the biomass may be administered to reaction equipment at room temperature and atmospheric pressure. An extruder, such as an auger may also easily be operated at increased pressures, such as 100 Bar or more.

The energy demanded by pyrolysis can be achieved by either indirect heating through the reactor walls or direct heating via solid heat carrier materials. Inert solid heat carriers (sand, steel shots, ceramic balls, silicon carbide, etc.) are recognized as an important method not only for fast pyrolysis conditions, but also for moving sufficient heat into extruders when they are scaled up. This heating method exhibits heat transfer conditions to perform fast pyrolysis, enabling to heat the feedstock not only from the hot reactor wall, but also and in major extent, through the direct contact with the solid heat carrier. Temperatures used are in the range of 400-600° C. [see Campuzano et al., Renewable and Sustainable Energy Reviews 2019, 102, 372]. A disadvantage of pyrolysis at these temperatures, is that although pyrolysis is fast, it is not selective, the pyrolysis products requiring many upgrading steps to improve purity due to the varied selectivity of the yield.

It is an objective of the present invention to overcome one or more of the abovementioned disadvantages, or at least to provide a useful alternative. It is a further objective of the present invention to provide a continuous process for the pyrolysis of biomass. Therefore, the present invention provides a process for the pyrolysis of biomass, comprising the following steps:
a) providing the biomass,
b) providing a salt,
c) combining the biomass and the salt,
d) feeding the combined biomass and salt to an extruder,
e) heating the combined biomass and salt in the extruder, thereby melting the salt if solid, and dissolving and/or dispersing the biomass in the molten salt,
f) transporting the mixture through the extruder at pyrolysis conditions, thereby creating liquid pyrolysis products, gases, and char,
g) removing the liquid pyrolysis products, gases, char and salt from the extruder,
h) separating the liquid pyrolysis products from the salt, the gases, and the char.

In the process according to the invention, instead of the commonly used solid heat transfer media such as sand, steel shots, ceramic balls, silicon carbide, etc., molten salt is simultaneously used as a heat carrier, catalyst, and solvent. To the inventor's best knowledge, this is the first time that a liquid heat transfer medium, let alone a molten salt, has been used as a heat carrier for pyrolysis in an extruder.

In prior art molten salt pyrolysis and gasification procedures, the thermal decomposition of biomass is performed in a molten salt bath. Pyrolysis temperatures are somewhat lower than the traditional fast pyrolysis temperatures of between 400 and 600° C. For example, WO 2017007798 and Appelt et al. in Holzforschung 2014, 69, 523 disclose pyrolysis of lignin in eutectic salt mixtures at temperatures of between 300 to 450° C. and reaction times of 1-3 hours. The moderate temperatures avoid excessive gasification into non-condensable gases associated with partial combustion, such that the pyrolysis products require less extensive upgrading and refinement to generate useable yields. The optimum reaction temperature was found to lie between 350 and 400° C.

Surprisingly, the use of molten salt as a heat transfer medium for pyrolysis in an extruder, leads to a high yield and quality of the obtained pyrolysis products at low reaction temperatures and even shorter residence times (<1 hr), also for biomass which is normally difficult to handle, such as lignin. This is speculated to be the result of the quick temperature increase and excellent control of the process conditions (temperature, pressure, residence time), which seem to be possible due to the properties of an extruder in combination with an improved handling capability of biomass, when it is dissolved or suspended in liquid salt. There is a synergistic effect of performing the pyrolysis in molten salt and performing the pyrolysis in an extruder. A further surprising effect of the invention is a high yield of polypropylene.

As molten salts have a high heat capacity and thermal conductivity they are able to provide for a rapid response to various temperature settings applied to the reactor, thereby providing excellent control and tunability of the reaction. The melting temperature of salts varies widely, from room temperature to well over 1000° C., depending on the composition of the salt. Salts may be categorized in two groups: organic salts and inorganic salts. Organic salts contain at least one C—H bond, whereas inorganic salts do not. Organic salts typically have lower melting temperatures than inorganic salts, and may even be liquid at room temperature. Organic salts with a melting temperature below 100° C. are typically referred to as ionic liquids. Inorganic salts are nearly always solid at room temperature, but may have melting temperatures as low as 120° C., depending on their composition.

The process according to the present invention yields liquid pyrolysis products, and by-products, which are gases (also known as non-condensable gases, i.e. gases which remain in gas form at room temperature, which in the case of the present invention may for example be CO₂, ethylene, ethane, propylene, hydrogen, methane, and CO), and char.

Pyrolysis conditions are conditions at which the biomass is thermally decomposed. Generally, three pyrolysis products can be defined: liquid pyrolysis products, non-condensable gases, and char. The liquid pyrolysis products may consist of a water phase comprising mainly hydrophilic components, and an oil phase comprising mainly hydrophobic components. The liquid pyrolysis products are in the gas phase at the used pyrolysis temperatures, and are thus easily separated from the salt by removing them from the reactor in the gas phase and subsequently condensing them.

### DESCRIPTION OF EMBODIMENTS

Single and twin screw extruders are the two main types of extruders based on screw configuration. Twin screw extruders can be co-rotating or counter-rotating depending on direction of rotation. The screw fulfills two purposes: first, it mixes the material present in the extruder and second, it controls the residence time of the material in the reactor. Heat is transported along the tubular wall of the reactor. Preferably, the extruder is a twin screw extruder, more preferably a co-rotating extruder.

Preferably, the biomass has a maximum water content of 45 wt %, more preferably of 15 wt %. The less water, the less energy is needed for the pyrolysis process. Most preferably, the biomass has a water content of 5-15%. Biomass with a higher water content may suitably be dried to the desired water content.

The biomass is preferably in the form of particles with a size of less than 5 mm, such as between 1-2 mm (i.e. the diameter of the smallest sphere that may enclose the particle). The particles may be spherical, but other shapes may be present. The particles may be coagulated into bigger aggregates.

Preferably, the salt has a melting temperature lower than 400° C. At higher melting points, the pyrolysis temperature of the process of the present invention has to be increased accordingly, which leads to a decreased selectivity and liquid yield of the pyrolysis process. Preferably, the salt has a melting temperature lower than 300° C., more preferably lower than 260° C., most preferably lower than 220° C. The lower the melting temperature, the lower the possible pyrolysis temperature and therefore the higher the selectivity of the reaction towards valuable pyrolysis products. Furthermore, a lower melting temperature means that the liquefaction of the biomass may be performed at low temperatures, which decreases losses due to charring.

Preferably, the salt has a melting temperature in the range of 50-400° C., more preferably 50-300° C., even more preferably 80-260° C., most preferably from 80-220° C.

Preferably, the salt is an inorganic salt, as inorganic salts in spite of their sometimes low melting temperature commonly tend to be stable at the preferred pyrolysis temperatures. A further advantage of inorganic salts is that they have very favourable heat transfer characteristics, resulting in fast heating rates. Moreover, they are often catalytically active, thereby increasing the pyrolysis rate. More preferably, the inorganic salt is a mixture, even more preferably a mixture of compatible species, as such salt mixtures commonly have a lower melting temperature than the corresponding pure components. With compatible species is meant that the component species may form a new type of joint crystal lattice without demixing. Most preferably, the mixture is a eutectic mixture. In a eutectic mixture, the melting point is the lowest possible over all of the mixing ratios for the involved component species. Especially eutectic mixtures may have the low melting points of 120° C. as described above.

Table 1 below provides a (non-exhaustive) list of currently known eutectic compositions useable for the thermal processing of biomass. These salts comprise halides, nitrates, hydroxides or carbonates. Nitrite salts are also useable for the thermal processing of biomass. Halide salts are particularly preferred for their stability and relatively low melting points. Most preferably, the inorganic salt comprises a chloride.

TABLE 1

| | | | Melting |
|---|---|---|---|
| | | Molar | point |
| Molten salts | | ratio | (° C.) |
| Halides | AlCl₃—KCl | 67:33 | 128 |
| | AlCl₃—NaCl | 55:45 | 133 |
| | CuCl—KCl | 65:35 | 150 |
| | ZnCl₂—KCl—NaCl | 60:20:20 | 203 |
| | ZnCl₂—KCl—LiCl | 40:20:20 | 240 |
| | KCl—LiCl—NaCl | 36:55:09 | 346 |
| | ZnCl₂—KCl | 70:30 | 262 |
| | ZnCl₂—NaCl | 70:30 | 255 |
| | ZnCl₂—KCl—CuCl | 48.1:41.1:10.8 | 190 |
| | LiF—NaF—KF | 46.5:11.5:42 | 454 |
| | ZnCl₂ | — | 283 |
| Nitrates | KNO₃—NaNO₃ | 55.8:44.2 | |
| | LiNO₃—NaNO₃—KNO₃ | 32.8:20.5:46.7 | 118 |
| | KNO₃—NaNO₂—NaNO₃ | 53.1:40.1:6.8 | 142 |
| Hydroxides | NaOH | — | 318 |
| | NaOH—KOH | 51.15:48.5 | 170 |
| Carbonates | Na₂CO₃—Li₂CO₃—K₂CO₃ | 29.8:44.1:26.1 | 395 |
| | Na₂CO₃—K₂CO₃ | 54.3:45.7 | 710 |

Particularly preferred inorganic salts are mixtures comprising CuCI and/or ZnCl₂. Both species have been shown to provide excellent results. Particularly CuCI has a relatively low melting point and high hydrolytic stability, thereby preventing any HCl formation. Most preferably, the inorganic salt is a eutectic mixture of either ZnCl₂:KCl:NaCl 60:20:20 or CuCl:KCl 65:35. ZnCl₂:KCl:NaCl 60:20:20 in particular has a very favorable stability in water and releases a considerably low amount of HCl.

Alternatively, the salt may be an organic salt. These salts may have a particularly low melting point. However, they are generally not stable at pyrolysis temperatures. Yet, there are species which have been shown to be stable at the preferred pyrolysis temperatures, such as organic salts which comprise a phosphonium cation of chemical formula (I) and/or a sulfonium cation of chemical formula (II)

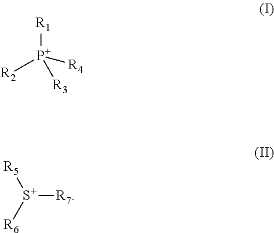

In formula (I), preferably at least one of R₁-R₄ comprise an aromatic group, more preferably all of R₁-R₄ comprise an aromatic group, even more preferably R₁-R₃ are a phenyl group. Most preferably the organic salt comprises a phosphonium cation of chemical formula (Ia)

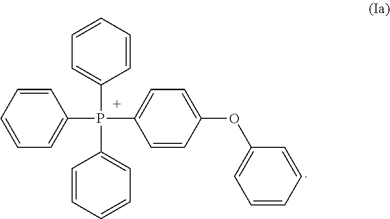

In formula (II) preferably at least one of R₅-R₇ comprise an aromatic group, more preferably all of R₅-R₇ comprise an aromatic group, even more preferably R₅-R₆ are a phenyl group.

The preferred anion in the organics salts of the present invention are anions of chemical formula (III)

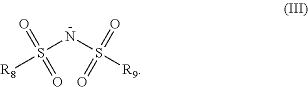

Preferably R₈ and R₉ comprise a C₁₋₄ alkyl group, more preferably a C₁₋₄ alkyl group substituted with at least one halogen atom, yet more preferably a C₁₋₄ alkyl group fully substituted with halogen atoms, even more preferably Fluorine atoms, most preferably an anion of chemical formula (IIIa) or (IIIb):

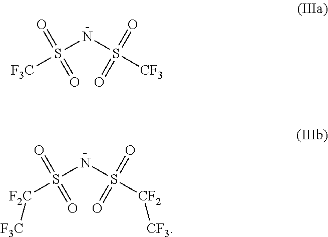 [SMILES: O=S(=O)(NS(=O)(=O)C(F)(F)F)C(F)(F)F ; O=S(=O)(NS(=O)(=O)C(F)(F)C(F)(F)F)C(F)(F)C(F)(F)F]

Biomass with a high percentage of lignin yields pyrolysis oil which comprises valuable alkylphenols. The higher the amount of lignin, the higher the amount of alkylphenols.

Preferably, the biomass comprises at least 10 wt % lignin, even more preferably at least 20 wt % lignin, even more preferably at least 50 wt % lignin, even more preferably at least 80 wt % lignin. Most preferably the biomass consists essentially of lignin. The process of the invention has particularly favorable results in the case of lignin-rich biomass. Examples of biomass comprising at least 10 wt % lignin are wood and straw. Wood commonly comprises from about 15 wt % to 40 wt % lignin. The main pyrolysis products of wood, when pyrolysed with the process of the present invention are acetic acid and furfural. An example of biomass consisting essentially of lignin is for example kraft lignin, which is a by-product of the pulping process.

Preferably, in step c) the weight percentage of biomass is between 1-50 wt %, such as between 2-49 wt %, of the total of biomass and salt combined. At higher percentages, the mixture is not adequately conveyable through the extruder, whereas at lower percentages, the amount of biomass is too low for the process to be economically viable. A somewhat lower amount of biomass leads to better processability. Thus, preferably, in step c) the weight percentage of biomass is between 5-30 wt %, of the total of biomass and salt combined. Most preferably in step c) the weight percentage of biomass is between 5-15 wt %, of the total of biomass and salt combined, as this ratio provides the optimum balance between economic viability of the process, and handling of the biomass.

Traditionally, temperatures used for fast pyrolysis are in the range of 400-600° C. In the method of the present invention, the temperature may be lower than this. Preferably the pyrolysis conditions comprise a pyrolysis temperature between 200 and 400° C. At these moderate temperatures, gasification into non-condensable gases associated with partial combustion is avoided to an even better extent than prior art fast pyrolysis processes, such that the pyrolysis products require even less extensive upgrading and refinement to generate useable yields. Moreover, the lower the temperature, the less energy is needed, making the process more sustainable. However, at temperatures which are too low, i.e. below 200° C., the reaction to pyrolysis products does not run to completion and/or the required reaction times become too long. More preferably the pyrolysis conditions comprise a pyrolysis temperature of between 220 and 380° C., even more preferably of between 240 and 360° C., even more preferably of between 240 and 300° C., most preferably of between 240 and 280° C. The consecutive ranges provide an increasingly sharp optimum between reaction rate and quality of the pyrolysis products.

In spite of the preferred relatively low pyrolysis temperatures, reaction times may be relatively short. Preferably, the pyrolysis conditions comprise a reaction time of between 1 and 200 minutes. At longer reaction times, the reaction does not lead to more valuable products, and even degradation of the valuable products may occur. Shorter times lead to a faster and less energy consuming process, but may result in incomplete pyrolysis and therefore less yield. More preferably, the pyrolysis conditions comprise a reaction time of between 1 and 30 minutes, even more preferably of between 2 and 20 minutes, most preferably of between 5 and 10 minutes. These consecutive ranges provide an increasingly sharp optimum between speed and quality of the pyrolysis products.

Preferably, the process is performed under atmospheric pressure, either in an ambient atmosphere, or under an inert atmosphere, such as under nitrogen gas. Thus, preferably, the process is performed in absence of oxygen. Increased pressures are also easily applied in the extruder. Preferably, the pyrolysis conditions comprise a pressure of between 1 and 200 Bar, more preferably of between 1 and 100 Bar, most preferably of between 1 and 60 Bar. The pyrolysis conditions may also comprise a hydrogen atmosphere for hydropyrolysis. The hydrogen atmosphere may be a full or a partial hydrogen atmosphere, for example in the case of a partial hydrogen atmosphere, the atmosphere may be a mixture of hydrogen and an inert gas, such as a mixture of hydrogen and nitrogen and/or argon. For hydropyrolysis, preferably the partial hydrogen pressure is between 1 and 100 Bar, more preferably between 20 and 80 Bar, even more preferably between 30 and 60 Bar. Hydropyrolysis leads to a further improvement of yield and quality of the pyrolysis products due to an increased level of CH in the products. Products with in increased levels of CH have a higher heating value.

The pyrolysis products preferably comprise alkylphenols, acetic acid and/or furfural, and the yield of separated pyrolysis products is preferably at least 10 wt %, more preferably at least 20 wt %, most preferably at least 30 wt % based on the amount of provided biomass.

Preferably, the pyrolysis products comprise propylene, more preferably the pyrolysis products comprise at least 5 wt %, such as at least 10 wt % of propylene.

Furthermore, in an extruder, the liquefaction process, i.e. the process of dissolving and/or dispersing the biomass in the molten salt (step e) may be spatially separated from the pyrolysis process (step f). This may be achieved by dividing the extruder into different zones. Spatially separated herein means that the reactor is operated at different conditions for different zones along the length of the reactor, but not that there is any separation between the zones. This cannot be the case in an extruder. On the contrary, in an extruder, the zones are seamlessly connected to each other.

Thus, step e) may be performed in an upstream zone of the extruder, and step f) may be performed in a downstream zone of the extruder, wherein the lowest temperature of the downstream zone is higher than the highest temperature of the upstream zone. Thus, the upstream zone has a relatively lower liquefaction temperature, and the downstream zone has a relatively higher pyrolysis temperature. It is understood that the upstream zone and downstream zone may each individually be comprised of at least two subzones. Thus, in an embodiment, step e) is performed an upstream zone (or multiple upstream subzones) of the extruder, preferably at a liquefaction temperature (or temperatures), and step f) is performed in a downstream zone (or multiple downstream subzones), preferably at a pyrolysis temperature (or temperatures), which is (or are) suitably higher than the liquefaction temperature (or temperatures). As both zones are part of the same reactor, the downstream zone is seamlessly connected the upstream zone. Operating different zones at different temperatures has the advantage that the conditions for liquefaction as well as for pyrolysis may be optimized, thereby increasing the yield of valuable products.

Preferably, the temperature in the upstream zone is lower than 250° C., more preferably lower than 240° C., even more preferably lower than 230° C., yet more preferably lower than 220° C.

Preferably, the temperature in the downstream zone is higher than 220° C., such as between 220 and 400° C. or between 220 and 380° C., more preferably higher than 240° C., such as between 2040 and 400° C., preferably between 240 and 360° C., even more preferably of between 240 and 300° C., most preferably of between 240 and 280° C.

In a further embodiment, it is possible to operate the extruder with a temperature gradient, gradually increasing the temperature from liquefaction conditions to pyrolysis conditions.

Furthermore, for each of the embodiments, by adjusting the speed of the screw of the extruder, and optionally the relative length of each zone, the residence time in the reactor, and optionally in each zone, may easily be adjusted, thereby optimizing the process, and the yield of valuable pyrolysis products.

In order to improve the yield, the gases, notably the non-condensable gases, removed in step g) may be recirculated to the extruder. The pyrolysis conditions may thus include a partial atmosphere of recirculated gas. This may improve the yield of liquid pyrolysis products. The gases may be recycled to any one of the zones or subzones in the extruder.

Preferably, the salt is purified and recycled to step b). For example, the salt may be purified in its liquid state by hot filtration, thereby removing the solids/char. Alternatively, the salt may be dissolved in water, followed by removal of solids (char), and evaporation of water to regain the salt.

### BRIEF DESCRIPTION OF THE DRAWINGS

FIG. 1 provides a schematic overview of a setup in which the process according to the invention may be performed.

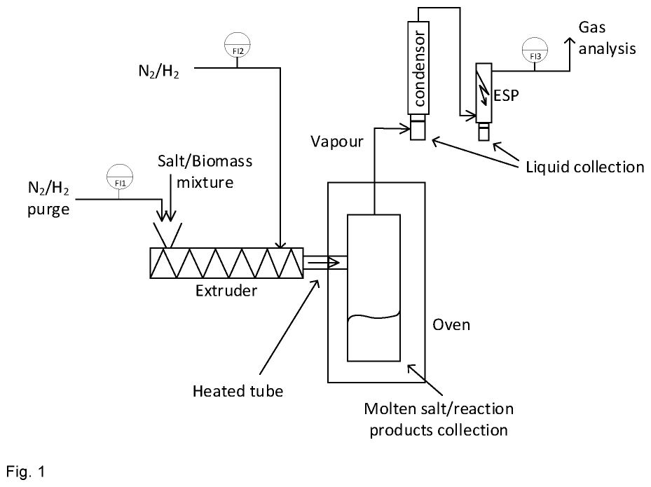

FIGS. 2a and 2b provide the results of the liquefaction experiment described in Example 1. Char yield and lignin recovered post extrusion is plotted against extruder rpm at lignin-molten salt ratios of 1:10 (FIGS. 2a) and 1:5 (FIG. 2b).

### EXAMPLE 1: LIQUEFACTION OF LIGNIN

An extruder, equipped with two co-currently operated screws connected to a drive motor was heated to 230° C. The torque from the drive motor and the extrusion pressure were measured online. The rotational speed of the screws was varied, providing good control over the residence time. The lignin/salt mixture to be processed was fed from a hopper to the extruder. At the end of the extruder, the product was collected. Lignoboost (referred to as Lignin-1) was used as the lignin of choice while a ZnCl₂: KCl:NaCl salt mixture with a composition of 60:20:20 mol % (salt composition #1) was used as the molten salt. The effects of the rotational speed of the extruder and the lignin-molten salt mass ratio on the lignin conversion after liquefaction were investigated. Table 2 gives an overview of the experiments performed in the extruder.

TABLE 2
Overview of liquefaction experiments performed in the twin-screw
extruder (230° C., ZnCl₂—KCl—NaCl, 60-20-20)

| | Extruder | Lignin- |
|---|---|---|
| | rotational | Salt |
| Experiment ID | speed (rpm) | Ratio |
| ABC-EXT1 | 20 | 1:10 |
| ABC-EXT2 | 20 | 1:5 |
| ABC-EXT3 | 60 | 1:10 |
| ABC-EXT4 | 60 | 1:5 |
| ABC-EXT5 | 120 | 1:10 |
| ABC-EXT6 | 120 | 1:5 |

Product workup involved separating the processed lignin, char and molten salts. The salts were removed by washing the extruded samples in hot water (40° C.) for a period of 48 h. The remaining char and processed lignin were separated by a treatment with DMSO (dimethyl sulfoxide). It is well known that unconverted lignin is soluble in DMSO, whereas highly condensed lignin (char) is not. This char/lignin separation allowed quantification of the amount of recovered lignin and the loss of lignin in the form of char during the liquefaction process (loss of lignin in the form of gases during liquefaction was negligible). The char yield and total mass balance were defined to evaluate the liquefaction process:

$$Total Mass Balance = \frac{Mass of organic matter ( processed Lignin + Char ) obtained after extrusion}{Total mass of lignin fed to the extruder}$$

$$Char Yield = \frac{Mass of DMSO insolubles in extruded product}{Total mass of lignin fed to the extruder}$$

### Liquefaction Results

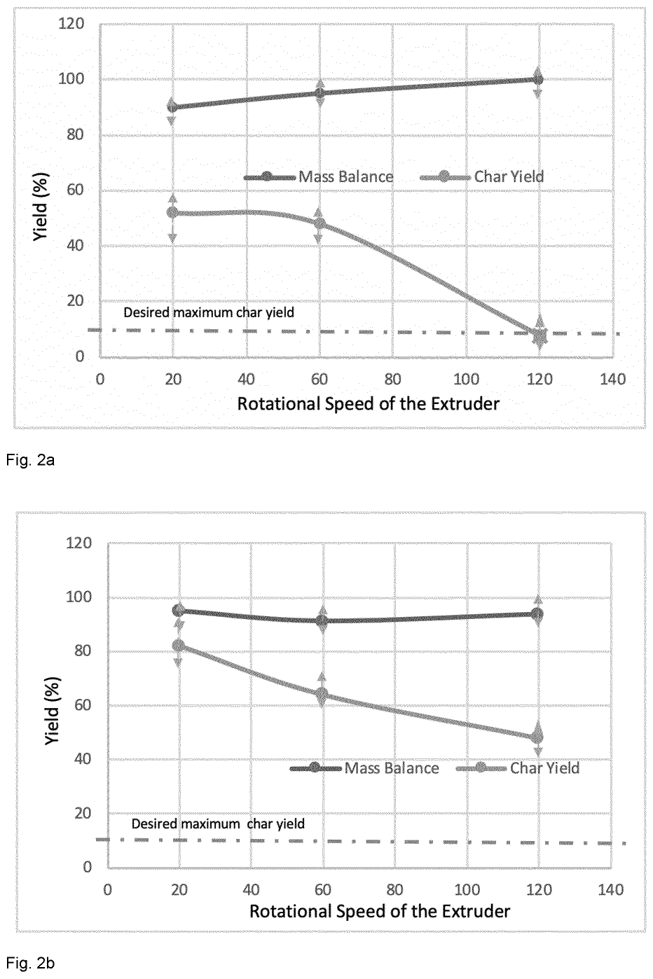

Char yield and the total mass balance are shown in FIG. 2. The char yield is a strong function of the rotational speed of the extruder. A low rotational speed results in by far higher char yields, both for the 1 to 10 (10 wt. % lignin) and 1 to 5 lignin-to-salt ratio (20 wt. % lignin). This may be rationalized by considering that low rotational speeds result in longer residence times in the extruder, leading to undesired condensation/charring of the lignin. Also, a higher amount of lignin in the composition gives a higher char yield. This may be a concentration effect; higher concentrations are expected to lead to higher rates of (higher order) condensation reactions. At a rotation rate of 120 rpm, and 10 wt. % lignin, the char yield is 8% is after liquefaction.

Comparative liquefaction experiments are performed using lignin and sand with identical ratio's and rotational speeds as shown for the lignin and salt mixtures in Table 2. Char yields in all cases are >>10%, in most cases close to 100%.

Further comparative experiments are performed using pure lignin, without heat transfer medium and identical rotational speeds as above (20, 60 and 120 rpm). Char yields in all three cases are >>10%.

Thus, these results show that liquefaction of lignin in molten salt in a an extruder can be performed without considerable losses of lignin in the form of char, which is a vast improvement with respect to a setup wherein sand is used as a heat transfer medium, or a setup wherein no heat transfer medium is used.

### EXPERIMENT 2: LIGNIN PYROLYSIS IN AN EXTRUDER

The experimental set-up used for these experiments consisted of an extruder with 6 temperature zones that can be set independently, a product collection vessel for spent salt and char, and a vapor condensation system for liquid collection. The extruder served both for liquefaction and pyrolysis of the lignin. Molten salt (ZnCl₂:KCl:NaCl 60:20:20) and lignin in a ratio of 5:1 were fed to the extruder at a rate of 240 g/h (100 rpm) under a protective atmosphere, liquefied at 230° C. and pyrolyzed at a temperature of 400° C. (the two zones directly after the feed hopper were set at 230° C. and the final 4 zones were set at 400° C.) The vapor was condensed in two stages, a condenser set at 5° C. and an ESP (electrostatic precipitator) at room temperature set at −7 kV. The liquids from the condenser and the ESP were collected and stored at 6° C. for analysis.

### Materials and Chemicals

LignoBoost was obtained from Valmet. The individual salt components ZnCl₂ (98%, Bochemie), NaCl (Food Grade, ESCO), and KCl (99%, K+S KALI GmbH) were obtained from Jagro Solutions BV and dried at 150° C. for 24 h before use. The purge gas (H₂ 5%; N₂ 95%) was obtained from SOL Nederland B.V.

### Experimental Procedure

The reactor was heated until the desired set-point temperatures were reached while flushing with a mixture of 95 v % Nitrogen (N₂) and 5 v % Hydrogen (H₂) with a flow rate of 0.3 L/min. The connecting tube between the extruder and the collection vessel was set to 500° C., the temperature of the collection vessel was set to 230° C. The extruder speed was 100 rpm and the N₂/H₂ flow rate at the gas injection point in extruder zone 5 (i.e. the zone prior to zone 6, after which material passing through the extruder leaves the extruder), was increased to 0.4 L/min. During operation the feed hopper of the extruder was flushed with purge gas at a rate of 0.2 L/min. Gas samples were collected at the outlet of the ESP using a gasbag and analyzed using GC.

In total 764 g of the salt/lignin mixture (20 wt % of lignoboost) was fed to the extruder. The salt and char residues were collected and weighed. The experiment provided a pyrolysis liquid, which consisted of two liquid phases, a heavy oil phase, and a water phase.

An overall carbon yield of 19.4% (based on dry input lignin) was determined with a liquid yield of 31.7 wt %. Further product yields, such as the propylene yield, are summarized in Table 4 below.

The experiment is repeated with the same parameters, with the exception of the purge gas being pure H₂, and the pressure in de extruder being 25 Bar instead of atmospheric pressure. The overall carbon and liquid yields are significantly higher than 20% and 32%, respectively, indicating the further advantage of a hydrogen atmosphere.

In a comparative experiment, lignin is pyrolyzed under identical conditions (purge gas H2 5%; N2 95% at atmospheric pressure), but without a heat transfer medium. The overall carbon and liquid yields are significantly lower than 19% and 31%, respectively. Attempts to perform the same experiments with sand as a heat transfer medium (ratio sand:lignoboost 5:1 and 10:1) also result in significantly lower carbon and liquid yields (i.e. significantly lower than 19% and 31%, respectively). In both cases, there is no yield of propylene.

The experiments indicate that the use of molten salt as a heat transfer medium results in minimal char losses and a high liquid yield in a continuous extrusion pyrolysis process of lignin.

### EXPERIMENT 3: LIGNIN PYROLYSIS WITH MOLTEN SALT IN A BATCH AUTOCLAVE

A 100 mL parr autoclave reactor was used to perform batch hydropyrolysis of a mixture of lignin and molten salts (ZnCl₂:KCl:NaCl 60:20:20). 4 g of lignoboost and 20 g of molten salt mixture were mixed together and heated to 400° C. at ambient pressure and at an approximate heating rate of 20° C./min. Hydrogen was used as a carrier gas and its flow rate was regulated at 60 mL/min using a mass flow controller. The volatile pyrolysis products were separated from the permanent gases using an ice cooled condenser. The product line from the reactor to the condenser was traced at 250° C. The reactor was cooled down after a batch time of 15 mins at 400° C. The mass of liquid products collected from the condenser was measured to compute the liquid yield. The composition of the permanent gases was determined using GC-TCD analysis. Char yield was computed by measuring the difference in weight of the reactor sleeve. Gas yield was determined by difference. Yields are summarized in Table 4 below.

Lignin pyrolysis without molten salts in a batch autoclave was performed in a similar fashion as described above, with the difference being the absence of the salt. Yields are summarized in Table 4 below.

TABLE 4

| | | | | | propylene |
|---|---|---|---|---|---|
| | solid | liquid | gas | propylene | carbon yield |
| Description | (wt %) | (wt %) | (wt %) | (wt %) | (%) |
| 3a. batch without | 81 | 14 | 6 | <1 | <1 |
| salt | | | | | |
| 3b. batch with | 86 | 9 | 5 | <1 | 1 |
| salt | | | | | |
| 2a. extruder with | 66 | 31 | 3 | 9.3 | 13.6 |
| salt | | | | | |

The pyrolysis tests presented in Table 4 all resulted in solid, liquid and gaseous pyrolysis products. The weight percentages are reported in Table 4. Propylene, if present, was collected in a condensed, liquid form.

It can be concluded from the experiments that performing pyrolysis in an extruder with molten salt leads to excellent results as compared to pyrolysis in an extruder without molten salt, as well as compared to batch pyrolysis in molten salt. The liquid yield is higher than what might be expected based on a mere combination of both measures (use of an extruder, and use of molten salt). Moreover, surprisingly, pyrolysis in an extruder with molten salt leads to a very high propylene yield. Such a high propylene yield could not be expected nor predicted based on any prior art disclosure.

1. A process for the pyrolysis of biomass, comprising the following steps:
a) providing the biomass,
b) providing a salt,
c) combining the biomass and the salt,
d) feeding the combined biomass and salt to an extruder,
e) heating the combined biomass and salt in the extruder, thereby melting the salt if solid, and dissolving and/or dispersing the biomass in the molten salt,
f) transporting the mixture through the extruder at pyrolysis conditions, thereby creating liquid pyrolysis products, gases, and char,
g) removing the liquid pyrolysis products, gases, char and salt from the extruder,
h) separating the liquid pyrolysis products from the salt, the gases and the char, wherein in step c) the weight percentage of biomass is between 5-30 wt % of the total of biomass and salt, and wherein the pyrolysis conditions comprise a pressure of between 1 and 200 Bar.

2. The process according to claim 1, wherein the extruder is an auger.

3. The process according to claim 1, wherein step e) is performed in an upstream zone of the extruder, and step f) is performed in a downstream zone of the extruder, wherein the lowest temperature of the downstream zone is higher than the highest temperature of the upstream zone.

4. The process according to claim 1, wherein the salt has a melting temperature lower than 400° C., preferably lower than 300° C., more preferably lower than 260° C., most preferably lower than 220° C.

5. The process according to claim 1, wherein the salt is an inorganic salt.

6. The process according to claim 5, wherein the inorganic salt comprises a halide, nitrate, nitrite, hydroxide or carbonate, preferably wherein the inorganic salt comprises a halide, more preferably a chloride.

7. The process according to claim 5, wherein the inorganic salt is a mixture, preferably a eutectic mixture.

8. The process according to claim 5, wherein the inorganic salt comprises CuCl and/or ZnCl₂, preferably wherein the inorganic salt is a eutectic mixture chosen from ZnCl₂:KCl:NaCl 60:20:20 and CuCl:KCl 65:35.

9. The process according to claim 1, wherein the salt is an organic salt.

10. The process according to claim 9, wherein the organic salt comprises a phosphonium cation of chemical formula (I) and/or a sulfonium cation of chemical formula (II) 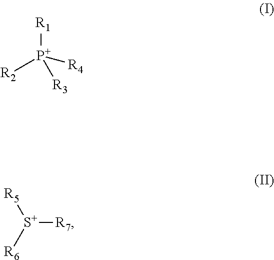
preferably wherein at least one of R1-R4 and R5-R7 comprise an aromatic group, more preferably wherein all of R1-R4 and R5-R7 comprise an aromatic group, even more preferably wherein R1-R3 and R5-R6 are a phenyl group, most preferably wherein the organic salt comprises a phosphonium cation of chemical formula (Ia)

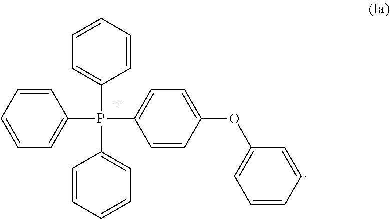

11. The process according to claim 9, wherein the organic salt comprises an anion of chemical formula (III) 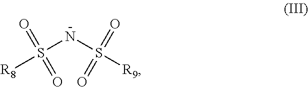
preferably wherein R8 and R9 comprise a C1-4 alkyl group, preferably a C1-4 alkyl group substituted with at least one halogen atom, more preferably a C1-4 alkyl group fully substituted with halogen atoms, even more preferably Fluorine atoms, most preferably an anion of chemical formula (IIIa) or (IIIb):

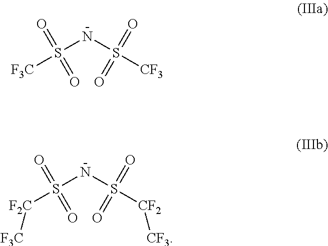 [SMILES: O=S(=O)(NS(=O)(=O)C(F)(F)F)C(F)(F)F ; O=S(=O)(NS(=O)(=O)C(F)(F)C(F)(F)F)C(F)(F)C(F)(F)F]

12. The process according to claim 1, wherein the biomass comprises at least 10 wt % lignin, preferably at least 20 wt % lignin, more preferably at least 50 wt % lignin, even more preferably at least 80 wt % lignin, most preferably wherein the biomass consists essentially of lignin.

13. The process according to claim 1, wherein in step c) the weight percentage of biomass is between 5-15 wt %.

14. The process according to claim 1, wherein the pyrolysis conditions comprise a pyrolysis temperature of between 200 and 400° C., preferably of between 220 and 380° C., more preferably of between 240 and 360° C., even more preferably of between 240 and 300° C., most preferably of between 240 and 280° C.

15. The process according to claim 1, wherein the pyrolysis conditions comprise a reaction time of between 1 and 200 minutes, preferably of between 1 and 30 minutes, more preferably of between 2 and 20 minutes, most preferably of between 5 and 10 minutes.

16. The process according to claim 1, wherein the pyrolysis conditions comprise a pressure of between 1 and 100 bar, more preferably between 1 and 60 Bar.

17. The process according to claim 1, wherein the pyrolysis conditions comprise a full or partial hydrogen atmosphere for hydropyrolysis, preferably at a partial hydrogen pressure of between 1 and 100 Bar, more preferably between 20 and 80 Bar, even more preferably between 30 and 60 Bar.

18. The process according to claim 1, wherein the residence time of the biomass in the extruder is less than 30 minutes, preferably less than 20 minutes, more preferably less than 10 minutes, most preferably less than 5 minutes.
